(19) United States
(12) Patent Application Publication
(10) Pub. No.: US 2009/0100376 A1
(43) Pub. Date: Apr. 16, 2009

(54) Method and apparatus for scheduling a reading list

(75) Inventors: Nisha Patel, Bangalore (IN); Jithin Jose, Idukki District (IN)

Correspondence Address: MENDELSOHN & ASSOCIATES, P.C., 1500 JOHN F. KENNEDY BLVD., SUITE 405, PHILADELPHIA, PA, 19102, US

(73) Assignee: Agere Systems Inc.

(21) Appl. No.: 11/973,726

(22) Filed: Oct. 10, 2007

(51) Int. Cl. G06F 3/048; G06F 17/00

(52) U.S. Cl. 715/810; 707/100; 707/E17.116

(57) ABSTRACT

During Internet and/or file browsing, a user may encounter files or Internet web pages of interest. The user may wish to store information about these files or pages for later consumption, but not the whole file or webpage. This is especially useful for mobile devices since storage space is limited and download rates may be slow. The user may store information about the files or web pages so they may later return to them without the need to store the entire file and use valuable storage space. Such information may be stored in reading lists via a database. Included with the information may be further information about downloading or reading the files of interest.

### FIELD OF THE INVENTION

The present invention relates generally to browser plug-ins and more particularly to reading lists.

### BACKGROUND OF THE INVENTION

During the course of internet browsing, file searching, and other related activities, users at a computer (e.g., PC, wireless device, mobile telephone, etc.) may want to save files, websites, pages, etc. for later review. Users may also wish to organize these items according to a reading priority or in a list of items to be read. Currently, users must save these items as bookmarks, internet favorites, or the like. In order to determine and/or schedule a time for later review, users must manually (e.g., on paper) schedule and/or access a separate program such as a calendar or To Do list.

Unfortunately, these various methods of file storage and subsequent scheduling are not very compatible and do not provide a seamless way of organizing and scheduling reading lists.

Therefore, alternative components and methods are required to organize and schedule reading lists.

### BRIEF SUMMARY OF THE INVENTION

The present invention provides improved methods and apparatus for creating a reading list in a computer browser. Such a browser may be in any device (e.g., a computer, mobile phone, PDA, or other embedded devices). Also, the browser could be an internet browser, a file browser, an email browser, etc. This may be accomplished by storing an indication of the location of the item, such as a Uniform Resource Location (URL) or file path in a database and associating the indication of the location of the item with scheduling information. The reading list, including an indication of the item, may be displayed in a browser window in response to a user input. The database may store instructions for automatically downloading the item at a scheduled time or displaying a reminder indicative of the item at the scheduled time.

These and other advantages of the invention will be apparent to those of ordinary skill in the art by reference to the following detailed description and the accompanying drawings.

### BRIEF DESCRIPTION OF THE DRAWINGS

FIG. 1 depicts a database according to an embodiment of the present invention;

FIG. 2 illustrates a reading list according to an embodiment of the present invention;

FIG. 3 is an illustration of a flowchart of a method of creating a reading list according to an embodiment of the present invention; and

FIG. 4 is a schematic drawing of a computer according to an embodiment of the invention.

### DETAILED DESCRIPTION

The present invention generally provides methods and apparatus for administering reading lists.

During Internet, email, and/or file browsing, a user may encounter files, emails, attachments, or Internet web pages of interest. The user may wish to store information about these files or pages for later consumption, but not the whole file or webpage. This is especially useful for mobile devices (e.g., Personal Digital Assistants (PDAs), Blackberrys, mobile telephones, notebook computers, etc.) since storage space is limited and download rates may be slow. However, this may also be useful for computers connected to a network, personal computers (e.g., desktops), etc.

The user may store information about the files or web pages so they may later return to them without the need to store the entire file and use valuable storage and/or cache space. Such information may be stored in electronic reading lists via a database. Reading lists (e.g., To Read lists) may be similar to and/or incorporated (e.g., as a plugin) into To Do lists, calendars, or other schedules, but may also include scheduling information for the files and web pages.

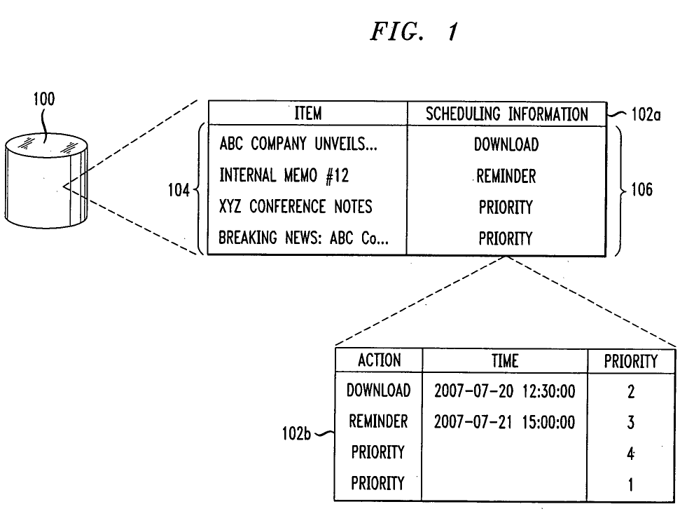

FIG. 1 depicts a database 100 according to an embodiment of the present invention. Database 100 includes one or more tables 102a and 102b. Tables 102a-b may include a list of items 104 (e.g., items to be read) and/or a list of scheduling information 106.

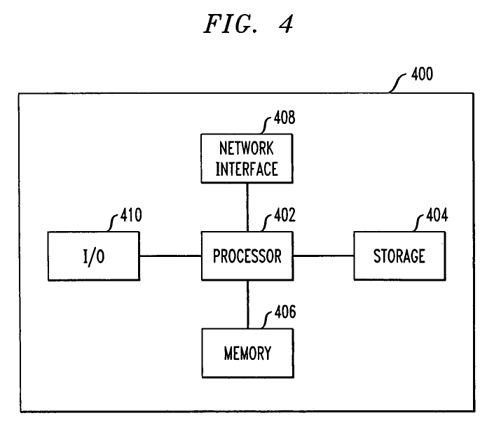

Database 100 may be collection of data that is stored in a computer (e.g., computer 400 of FIG. 4) wherein a database management system (DBMS) may consult the database 100 to answer queries (e.g., to select data). Data retrieved in answer to queries becomes information that can be used to make decisions, may precipitate actions, or may be displayed to a user.

For simplicity, database 100 is depicted and described in the embodiment of FIG. 1 as a relational database. In the same or alternative embodiments, all or part of database 100 may configured according to another database model such as a hierarchical model, a table model, a network model, an object model, an associative model, etc. According the database model, database 100 may have an associated database structure. Such a data structure may define the manner in which information is stored and/or organized in the database 100 and may include such information (e.g., data, etc.) as will be discussed below with respect to tables 102a-b, though other data structures may be used.

Tables 102a-b may be data tables as is known in the use of databases. It is understood that though represented in FIG. 1 as two tables 102a and 102b, any number of tables may be used to store and correlate data. Similarly, though depicted as tables, tables 102a-b are a visual representation of a database relation and any appropriate implementation of data storage and correlation may be used.

Tables 102a-b may be a set of data elements organized using rows and columns which may be accessed via the DBMS (e.g., as in a look-up table). The columns may be identified by title (e.g., “Item” and “Scheduling Information”) or another identifier. The rows may be identified by the values (e.g., “ABC Company Unveils . . . ”, “Download”, Internal Memo #12”, etc.) appearing in a particular column. In some embodiments rows may also have titles or other identifiers.

The list of items 104 may include data values as described above, such as a list or other indication of a location of an item, a link to an item, a URL pointing to a webpage, a bookmark or similar indication, a path indicating a file stored on a network, hard drive, or other storage location, and/or any other appropriate pointer to and/or indication of an item. In the context of the present invention, an item may be any item to be read by a user, such as an Internet webpage, a document, a spreadsheet, a file, etc.

Scheduling information 106 may be a list of scheduling information to be associated with the list of items 104. In the particular embodiment shown in FIG. 1, the scheduling information 106 may be stored (e.g., listed) along with the list of items 104 in tabular form. It may be understood that any other arrangement (e.g., arrays, connection pathways, etc.) may be used to associate the scheduling information 106 with the list of items 104.

Scheduling information 106 may include an indication of a time to automatically download an item from the list of items 104. Additionally and/or alternatively, the scheduling information 106 may include an indication of a time to send an alert (e.g., a reminder) to download and/or read an associated item. Other scheduling information may be used, such as a priority, a correlation with a calendar, placement on a To Do list, inclusion of an indication of the read status (e.g., read, partially read, unread), etc.

Further, the scheduling information 106 may refer to and/or include instructions for performing the actions indicated in the scheduling information 106 list. The actions may be performed by an outsides source (e.g., a software application associated with a reading list 200 and/or computer 400, both discussed below). For example, “ABC Company Unveils . . . ” from the list of items 104 may be associated with scheduling information 106 “Download.” The scheduling information “Download,” when accessed by the DBMS, may cause one or more components of computer 400 to perform the download. That is, instructions stored at the storage device 106 may access the file “ABC Company Unveils . . . ” form the location indicated in the list of items 104 and may initiate a download process to a server, a network, a hard drive, another storage location, a software application, a user interface, a display, etc. Any other appropriate method of acting on the scheduling information 106 by any combination of software and/or hardware may be employed. Methods of accessing and handling files are well known and are not discussed in detail herein except to refer generally to their uses in accordance with implementation of the present invention.

Tables 102a-b may be related in a hierarchical structure in that table 102b may provide further information about table 102a. In the exemplary embodiment of FIG. 1, table 102b may include further scheduling information related to the values included in table 102a. For example, the Item “ABC Company Unveils . . . ” from the list of items 104 may be associated with scheduling information 106 “Download” which may have additional information associated with it. This information may be stored in table 102b as the Action “Download” at Time “2007-07-20 12:30:00” with Priority “2”.

In this way, tables 102a-b (and other tables) may nest or otherwise store information (e.g., data values) which may be retrieved by the DBMS.

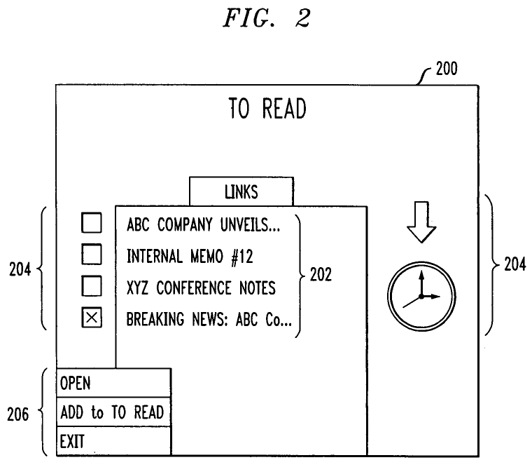

FIG. 2 illustrates a reading list 200 according to an embodiment of the present invention. Reading list 200 comprises a reading menu 202 that may contain a list of items to be read. Displayed with and/or associated with the reading menu 202 may be scheduling indicators 204. The reading list 200 may further comprise a window menu 206.

Reading list 200 may be implemented as a software application or other user interface such as browser window, a plugin (e.g., extension) for a browser window or other interface, or as an enhancement to an existing user interface. The reading list 200 (e.g., a To Read list) may be similar to and/or implemented along with a To Do list or task list application. Such lists (e.g., reading list 200, etc.) may have built-in task hierarchy (e.g., tasks are composed of subtasks which again may contain subtasks) that correspond to the hierarchy of tables 102a-b of FIG. 1, and/or may support multiple methods of filtering and/or ordering the list of tasks. Thus, reading list 200 may be implemented as a personal information manager in conjunction with existing project management or similar software.

Reading menu 202 may include a list of items to be read. This list may correlate to the list of items 104 in database 100. That is, the reading menu 202 may display via a user interface such as reading list 200 a textual and/or graphical indication of one or more items to be read. Such indicators may include a title of the item, a review of the item, a summary of the item, a figure representing the item, or any other appropriate information. In some embodiments, the user may be able to configure the reading list 200 and the reading menu 202 to display the user's preferred indicators for all of the items or select items.

Scheduling indicators 204 may correlate to the scheduling information 106 in database 100. That is, the scheduling indicators 206 may display via a user interface such as reading list 200 a textual and/or graphical indication of the scheduling information associated with the list of items 104. As such, the scheduling indicators 206 may be associated with the reading menu 202 according to the relationships established in database 100 between the list of items 104 and the scheduling information 106.

For example, referring to the exemplary database 100 of FIG. 1, Item “ABC Company Unveils . . . ” in the list of items 104 may be associated with Scheduling Information “Download” from the scheduling information 106. In the reading list 200, “ABC Company Unveils . . . ” is thus displayed in the reading menu 202 along with a visual indication of a scheduling indicator 204 for downloading the file—in this case a downward pointing arrow. In another example, Item “Internal Memo #12” in the list of items 104 may be associated with Scheduling Information “Reminder” from the scheduling information 106. In the reading list 200, “Internal Memo #12” is thus displayed in the reading menu 202 along with a visual indication of a scheduling indicator 204 for a reminder—in this case a reminder clock. In still another example, Item “Breaking News: ABC Co . . . ” in the list of items 104 may be associated with Scheduling Information “Priority” from the scheduling information 106 in table 102a, which is expounded on by Priority “1” in table 102b. In the reading list 200, “Breaking News: ABC Co . . . ” is thus displayed in the reading menu 202 along with a visual indication of a scheduling indicator 204 for indicating the read status of the item—in this case a box that is markable to indicate that the item has been read. Any other appropriate visual representations may be used for the scheduling indicators 204. For example, the items in reading menu 202 may be highlighted, colored, re-ordered or otherwise indicate their reading priority as stored in database 100; the items in reading menu 202 may be displayed in a calendar according to their scheduling information from tables 102a-b; etc.

Window menu 206 may be a menu listing options for interacting with the reading list 200. Such menus are well-known and their implementation and functions are not described further herein except as they relate to the present invention.

Window menu 206 and the other aspects of the reading list 200 may be employed as in other browser windows. That is, various options may be available by using a mouse for clicking or right-clicking, using a keyboard shortcut, using a stylus or thumbwheel on a wireless device, etc.

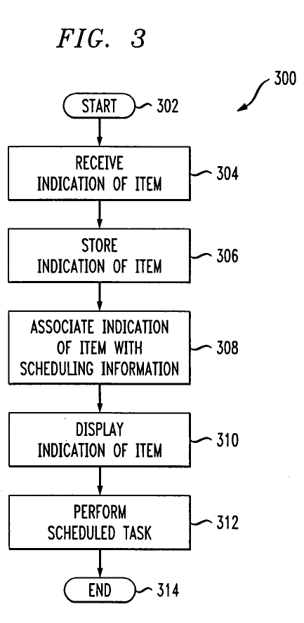

FIG. 3 is an illustration of a flowchart of a method 300 of creating a reading list according to an embodiment of the present invention. The method 300 is discussed with particular reference to the database 100 of FIG. 1, the reading list 200 of FIG. 2, and may utilize one or more components of computer 400 of FIG. 4 (discussed below). The method starts at step 302.

In step 304, an indication of an item is received. The indication of the location of the item may be a URL or other indication as described above and may be received via a user interface (e.g. reading list 200, etc.) and/or at database 100.

The indication may be entered (e.g., to be sent and received) via a user interface such as using “Add to To Read” from the window menu 206 of reading list 200. Other methods of entering and receiving the indication may be used. For example, a user may select an item during browsing using an I/O device 410, may click on or otherwise mark an item, and/or may enter an indication of the location of the item manually (e.g., type a URL or file path into an interface associated with database 100 and/or reading list 200).

In step 306, the indication of the location of the item is stored in database 100. The indication of the location of the item may be stored in tables 102a-b as described above or may use any other appropriate method. Additionally and/or alternatively, the indication of the location of the item may be stored in database 100 and/or memory 406 in any appropriate form, such as ordered and/or unordered flat files, according to Indexed Sequential Access Method (ISAM), in heaps, in hash buckets, in B+Trees, etc.

As discussed above with respect to step 304, the user may select the item for storage and may, in some embodiments, indicate the preferred method and/or location for storage. For example, in a network environment where a file is stored on a network computer or in another non-local location, a user using a handheld device may direct an indication of the file to be stored in a database located on communal server instead of storing the indication of the location of the item locally (e.g., on a hard drive of the handheld device). In this way, the user may save storage space on the handheld device, but may have access to the indication whenever connected to the network. In this example, the user must be connected to the network to access the file, so there is no disadvantage to storing the indication away from the handheld device. Of course, the indication of the location of the item may be stored in more than one location and may be available for access by more than one user. Any information associated with the indication (e.g., the item and/or the scheduling information discussed in step 308) may be stored similarly.

In step 308, scheduling information is associated with the indication of the location of the item. In at least one embodiment, the scheduling information may be stored in database 100 as scheduling information 106 and may be associated with indications of items in the list of items 104. Such scheduling information may include an Action, a Time for the Action (e.g., a scheduled time), and/or a Priority as shown in table 102b. Other scheduling information, such as an indication of an item's read status (e.g., read, unread, partially read, a percentage read, etc.), may be associated with the indication of the location of the item in this step.

Scheduling information may be associated with the indication of the location of the item by a user using an interface (e.g., reading list 200) similarly to the method steps 304 and 306 described above. For example, a user may associate with the web page “ABC Company Unveils . . . ” in the database 100 a Download operation at 12:30:00 on Jul. 20, 2007. In this way, the user will have scheduled an automatic download or download prompt at that time for that web page. Similarly, the user may assign a Priority “2” to “ABC Company Unveils . . . .” This priority may indicate that that download operation is to proceed after all Priority “1” tasks (e.g., reading “Breaking News: ABC Co . . . ”), may indicate the preferred, but not required reading order, or may indicate any other priority information.

Scheduling information may be associated in any appropriate way. In at least one embodiment, a user may access a calendar function (e.g., MS Outlook or similar) and select a date and time for the desired action. In the same or alternative embodiments, the user may associate scheduling information with items using an additional plugin entry system or a system built into the reading list 200.

In step 310, an indication of the location of the item is displayed. The indication of the location of the item (e.g., “Breaking News: ABC Co . . . ”) may be included in the reading menu 202 of reading list 200. In the same and/or alternative embodiments, an indication of the scheduling information (e.g., an X-ed box indicating the time has been read) may be displayed as scheduling indicators 206 in reading list 200.

In step 312, the scheduled task is performed. For example, since “Internal Memo #12” has a scheduled Action of a Reminder at 15:00 on Jul. 21, 2007, at that time the reading list 200 or another user interface provides an indication (e.g., graphical, auditory, text, etc.) of “Internal Memo #12” (e.g., via an alarm/alert). As seen in FIGS. 1 and 2, other indications and/or methods of performing the scheduled task may be accomplished. Though not explicitly described herein, it is understood that the computer 400 may accomplish tasks indicated in database 100 such as downloading, reminding, moving files, opening browsers, transferring files, emailing other parties, or any other appropriate tasks related to the list of items 104 as displayed in reading list 200.

The method ends at step 314.

FIG. 4 is a schematic drawing of a computer 400 according to an embodiment of the invention. Computer 400 contains a processor 402 which controls the overall operation of the computer 400 by executing computer program instructions which define such operation. The computer program instructions may be stored in a storage device 404 (e.g., magnetic disk, database, etc.) and loaded into memory 406 when execution of the computer program instructions is desired. Thus, applications for performing the herein-described method steps, such as scheduling actions associated with items to be read, are defined by the computer program instructions stored in the memory 406 and/or storage 404 and controlled by the processor 402 executing the computer program instructions. The computer 400 also includes one or more network interfaces 408 for communicating with other devices via a network. The computer 400 also includes other input/output devices 410 (e.g., display, keyboard, mouse, speakers, buttons, etc.) that enable user interaction with the computer 400. One skilled in the art will recognize that an implementation of an actual controller could contain other components as well, and that the computer of FIG. 4 is a high level representation of some of the components of such a controller for illustrative purposes.

Further, the computer 400 may be implemented on, may be coupled to, and/or may include any components or devices that are typically used by, or used in connection with, a computer or computer system. Computer 400 and/or processor 402 may include one or more central processing units, read only memory (ROM) devices and/or random access memory (RAM) devices.

According to some embodiments of the present invention, instructions of a program (e.g., controller software) may be read into memory 406, such as from a ROM device to a RAM device or from a LAN adapter to a RAM device. Execution of sequences of the instructions in the program may cause the computer 400 to perform one or more of the method steps described herein. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software. The memory 406 may store the software for the computer 400, which may be adapted to execute the software program and thereby operate in accordance with the present invention and particularly in accordance with the methods described in detail below. However, it would be understood by one of ordinary skill in the art that the invention as described herein could be implemented in many different ways using a wide range of programming techniques as well as general purpose hardware sub-systems or dedicated controllers.

Such programs may be stored in a compressed, uncompiled and/or encrypted format. The programs furthermore may include program elements that may be generally useful, such as an operating system, a database management system and device drivers for allowing the controller to interface with computer peripheral devices, and other equipment/components. Appropriate general purpose program elements are known to those skilled in the art, and need not be described in detail herein.

For purposes of illustration of the present invention, an exemplary operation of certain embodiments is now presented. This example is not intended to limit the invention, but merely to describe a use of the systems and methods described above with respect to FIGS. 1-4.

A user using a Blackberry to browse the Internet and a company's internal network may encounter a number of web pages and files of interest, shown in the list of items 104. The user utilizes the “Add to To Read” function of the window menu 206 of the reading list 200 to send an indication of the location of the items 104 to database 100 and to add the text “ABC Company Unveils . . . ”, “Internal Memo #12”, “XYZ Conference Notes”, and “Breaking News: ABC Co . . . ” to the reading menu 202.

During this browsing session, the user may realize there is insufficient time and/or bandwidth to download all of these items. Accordingly, the user may determine “Breaking News: ABC Co . . . ” is the most important document, download it, and schedule a Priority of 1 to the item. The user may then schedule an automatic download time of “2007-07-20 12:30:00” and Priority “2” for “ABC Company Unveils . . . ”, an automatic reminder time of “2007-07-21 15:00:00” and Priority “3” for “Internal Memo #12”, and a low Priority “4” to “XYZ Conference Notes.”

All of this information may be stored in database 100 and associated in the hierarchical structure of tables 102a-b. To facilitate review by the user, indications of the read status and any scheduled actions may be displayed with “ABC Company Unveils . . . ”, “Internal Memo #12”, “XYZ Conference Notes”, and “Breaking News: ABC Co . . . ” in the reading menu 202 as scheduling indicators 206.

When the user has completed reading “Breaking News: ABC Co . . . ”, the user may mark (e.g., by clicking a box next to the item in the reading menu 202) that the item has been read. In some embodiments, the reading list 200, the database 100, and/or the computer 400 may update the reading list at predetermined times and/or upon command from the user and the item “Breaking News: ABC Co . . . ” may be removed from the database 100 and/or the reading menu 202.

At 12:30 on Jul. 20, 2007, the database 100 via the DBMS may compel the computer 400 to download “ABC Company Unveils . . . ” and store the web page in memory 406. A visual or other indication of the download may be displayed for the user at this time. Additionally or alternatively, the entire file may be displayed for the user.

The foregoing description discloses only particular embodiments of the invention; modifications of the above disclosed methods and apparatus which fall within the scope of the invention will be readily apparent to those of ordinary skill in the art. For instance, it will be understood that, though discussed primarily a reading list implemented in a plugin for mobile devices, the present invention may be employed as a stand-alone software application and/or may be employed on a network environment or non-mobile device. Additionally, though discussed in the method steps individual steps, one or more of the method steps of method 300 may be combined and/or performed at the same time. Similarly, other components may perform the functions of method 300 even when not explicitly discussed. For example, though discussed as a database 100 stored at a memory 406, it may be understood that memory 406 may also included one or more features of computer 400, such as having the computer program instructions of storage device 406 and/or having structures configured to generate and issue control commands to a local and/or remote computer and/or software application.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A method of creating an electronic reading list comprising:
receiving an indication of a location an item;
storing the indication of the location of the item; and
associating the indication of the location of item with scheduling information.

2. The method of claim 1 further comprising:
transmitting the indication of the location of the item to a browser application.

3. The method of claim 1 further comprising:
transmitting a command to display the item in a browser window.

4. The method of claim 3 further comprising:
transmitting a command to display the associated scheduling information with the indication of the location of item in the browser window.

5. The method of claim 1 wherein the indication of the location of the item is stored in a database.

6. The method of claim 1 wherein the scheduling information is a scheduled time.

7. The method of claim 6 further comprising:
automatically transmitting a command to download the item at the scheduled time.

8. The method of claim 6 further comprising:
transmitting a command to display a reminder indicative of the item at the scheduled time.

9. A memory for storing data associated with a reading list for access by an application program being executed on a data processing system comprising:
a data structure stored in the memory, the data structure including information resident in a database used by the application program in according with the data structure, the database information including:
a list of locations of items; and
a list of scheduling information associated with the list of locations of items.

10. The memory of claim 9 wherein the list of locations of items comprises a list of Internet Uniform Resource Locations.

11. The memory of claim 9 wherein the list of locations of items comprises a list of files stored on a local hard drive.

12. The memory of claim 9 further comprising:
a system configured to automatically transmit a command to download one or more items indicated by the list of locations of items.

13. The memory of claim 9 further comprising:
a system configured to automatically transmit a command to display a reminder indicative of an item at a scheduled time, wherein the scheduled time is scheduling information associated with the listing of the location of the item in the list of locations of items.

14. A machine readable medium having program instructions stored thereon, the instructions capable of execution by a processor and defining the steps of:
receiving an indication of a location an item;
storing the indication of the location of the item; and
associating the indication of the location of item with scheduling information.

15. The machine readable medium of claim 14, the instructions defining the further step of:
transmitting the indication of the location of the item to a browser application.

16. The machine readable medium of claim 14, the instructions defining the further step of:
transmitting a command to display the item in a browser window.

17. The machine readable medium of claim 16, the instructions defining the further step of:
transmitting a command to display the associated scheduling information with the indication of the location of item in the browser window.

18. The machine readable medium of claim 14, the instructions defining the further step of:
storing the indication of the location of the item in a database.

19. The machine readable medium of claim 14 wherein the scheduling information is a scheduled time.

20. The machine readable medium of claim 19, the instructions defining the further step of:
automatically transmitting a command to download the item at the scheduled time.

21. The machine readable medium of claim 19, the instructions defining the further step of:
transmitting a command to display a reminder indicative of the item at the scheduled time.

22. A machine readable medium having program instructions stored thereon, the instructions capable of execution by a processor and defining the steps of:
displaying a user interface, the user interface displaying:
indications of one or more items; and
scheduling information associated with one or more of the items.

23. The machine readable medium of claim 22, the instructions defining the further step of:
receiving a command through the interface indicative of a user editing the indications of one or more items.

24. The machine readable medium of claim 22, the instructions defining the further step of:
receiving a command through the interface indicative of a user marking one or more items on the list of items as read.

25. The machine readable medium of claim 22, the instructions defining the further step of:
displaying through the user interface one or more items.
